(19) United States
(12) Patent Application Publication
(10) Pub. No.: US 2010/0037871 A1
(43) Pub. Date: Feb. 18, 2010

(54) INTERNAL COMBUSTION ENGINE

(76) Inventors: Hartmut Sauter, Renningen (DE); Bernhard Schwalk, Ludwigsburg (DE); Hans-Peter Drespling, Heidenheim (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/542,326

(22) Filed: Aug. 17, 2009

(30) Foreign Application Priority Data
Aug. 18, 2008 (DE) 102008038235.3

(51) Int. Cl. F02M 25/07; F01N 3/02

(52) U.S. Cl. 123/568.11; 60/311

(57) ABSTRACT

The present invention relates to an internal combustion engine 1, in particular in a motor vehicle, comprising an engine block 2 that contains a plurality of combustion chambers 3, a fresh-air apparatus 5, and exhaust-emission system 10, and an exhaust-gas recirculation system 15.

A purification system 29 for removing liquid or solid particles from the recirculated exhaust gas reduces the risk of damage to components of the fresh-air apparatus or of the exhaust-gas recirculation system.

The present invention relates to an internal combustion engine, in particular in a motor vehicle.

An internal combustion engine, as it is used in motor vehicles, has an engine block that contains combustion chambers in a central cylinder bank or in a plurality of cylinder banks. Said combustion chambers are configured in cylinders in which pistons are arranged in a stroke-adjustable manner. Here, a piston engine is concerned, for example a diesel engine or a petrol engine. The internal combustion engine has a fresh-air apparatus for supplying fresh air to the combustion chambers. Furthermore, an exhaust-emission system is Present for recirculating exhaust gas from the combustion chambers. In order to improve emissions values and consumption data, modern internal combustion engines are equipped with an exhaust gas recirculation system by means of which exhaust gas is recirculated from the exhaust-emission system to the fresh-air apparatus.

Furthermore, modern internal combustion engines are configured with charging equipment for increasing the pressure level in the fresh-air in the internal combustion engine, which is used for increasing the performance of the internal combustion engine. For the recirculation of exhaust gas, it is conventional in such charged internal combustion engines to configure the exhaust-emission system as a high-pressure exhaust-emission system. This means that a removal point, in which the exhaust-gas recirculation apparatus is connected to the exhaust-emission system, is positioned upstream from a turbine of the exhaust-gas turbocharger, while an introduction point, in which the exhaust-gas recirculation apparatus is connected to the fresh-air apparatus, is arranged downstream from a compressor of the exhaust-gas turbocharger. It is thereby prevented that impurities, which are carried along in the exhaust gas, reach the compressor where they can lead to damage. In principle, however, a configuration as a low-pressure exhaust-gas recirculation apparatus is also possible that is characterised in that the introduction point of the exhaust-gas recirculation apparatus is arranged downstream from the turbine of the exhaust-gas turbocharger, while the removal point of the exhaust-gas recirculation apparatus is arranged upstream from the compressor of the exhaust-gas turbocharger. There is a greater pressure loss available between the ES and the fresh-air apparatus on the low-pressure side, which makes the recirculation of the exhaust gas easier. Furthermore, the exhaust-gas recirculation rate is largely decoupled from the current charge pressure. Moreover, an improved mixing of the recirculated exhaust gas and the fresh air is achieved by the lengthy shared course from the introduction point to the combustion chambers. In a low-pressure exhaust-gas recirculation system, in particular in the use of a diesel engine, the removal point can advantageously be arranged downstream from a particle filter are arranged in the ES, said particle filter serving to remove soot particulates carried along in the exhaust gas, in order to prevent contamination or damage of the compressor by particles carried along in the exhaust gas.

Particle filters, which are used in exhaust-emission systems, as a rule contain a porous ceramic body through which the exhaust-gas stream can flow, however the soot particulates carried therein cannot. It has been shown that in the operation of an internal combustion engine, in particular in motor vehicles, ceramic particles become detached from the particle filter and are carried away in the exhaust-gas stream going to the stresses, vibrations, and shocks that arise. These particles can be comparably large. Furthermore, particles can become dislodged from the bearing material used to support the ceramic body in the housing of the particle filter, said particles likewise being carried along in the exhaust-gas flow. These particles can reach the compressor by means of the exhaust-gas recirculation and can lead to contamination, and in particular to damage, in the compressor. Dangerous above all is the great relative speed between a compressor wheel, which is rotating with a high degree of speed, and the particles entering into the compressor. Furthermore, these particles can also bring about damage downstream from the compressor wheel, for example in charge-changing valves or in the individual cylinders in piston guides.

In order to reduce the risk of damage of the compressor or of the compressor wheel, it is possible in theory to increase the resistance of the compressor wheel to the extent that the collisions with the particles are tolerable. The manufacture of such high-resistance compressor wheels is, however, comparably expensive.

The present invention addresses the problem of providing an improved embodiment for an internal combustion engine of the previously mentioned type, which embodiments is characterised, in particular, in that the risk is reduced that particles will damage components of the exhaust-gas recirculation system or of the fresh-air apparatus by means of the exhaust-gas recirculation.

This problem is solved by the subject matter of the independent claim. Advantageous embodiments are the subject matter of the dependent claims.

The invention is based on the general concept of removing the particles from the exhaust gas by means of a corresponding purification system. With the removal of liquid or solid particles from the recirculated exhaust gas, the risk of damage to components of the exhaust-gas recirculation system or of the fresh-air apparatus, which are flowed around or flowed through, can be significantly reduced. Purification system must be suitable for all occurring temperatures and must furthermore be aligned with regard to the particle size of the critical particles to be removed from the exhaust gas.

Corresponding to an advantageous embodiment, the purification system is to be arranged in the exhaust-gas recirculation system, by means of which all components of the fresh-air apparatus are in any case protected from being impinged upon with particles. Since the volume flow rate of the research related exhaust gas is relatively small, the purification system in this embodiment likewise be constructed in a compact manner and can moreover operate with a relatively low loss of pressure. It is likewise conceivable to arrange the purification system in the fresh-air apparatus for example upstream from each of the components to be protected, or in the exhaust-emission system between a particle filter and the removal point.

In an advantageous embodiment, the purification system is designed as a filter apparatus that comprises a filter body that can be flowed through, which exhaust gas can permeate, and through which the particles to be removed cannot pass. Such filter apparatuses are characterised by an extremely high purification performance. It is furthermore possible to provide a filter apparatus with a comparably low flow resistance. This is of particular advantage in the present use sense, as a rule, only a relatively minimal fall in pressure is present between the exhaust-emission system and the fresh-air apparatus in order to recirculate the exhaust gas.

Alternatively, it is possible in theory to also use other purification devices, such as, for example, an inertial separator, such as, for example, a cyclone or a centrifuge or an impactor.

A filter material for the filter body of the filter apparatus, metallic filter materials, for example, are in particular suited in an arrangement in the exhaust-gas recirculation system, such metallic filter materials being, for example, a naked wire mesh or a wire cloth or knitted wire filaments. Such metallic filter materials possess sufficient temperature stability. Furthermore, the wire cloth and knitted wire mesh are characterised by a comparably high filter performance while exhibiting a relatively low resistance to being flowed through.

Corresponding to yet another advantageous embodiment, the filter body can have a flange section that is arranged between flanges, which are attached to one another, of the filter housing and of the exhaust-gas recirculation system or of the fresh-air apparatus for positioning or fixing the filter body in a filter housing in the assembled state. Additional positioning elements or fixing elements can thus be dispensed with. The filter body can thus be advantageously automatically positioned and fixed upon installation of the filter housing in the exhaust-gas recirculation system or in the fresh-air apparatus. The installation, and in particular, an exchange of the filter body is thereby simplified.

In order to connect both of the flanges, which co-operate together, of the filter housing and the fresh-air apparatus or the exhaust-gas recirculation system in a gas-tight manner, a corresponding seal can be arranged between the flanges. According to an advantageous embodiment, this seal can be configured as integral with the flange section of the filter body. This manner of construction achieves that when the filter body is exchanged, the seal is likewise changed at the same time.

Additional important features and advantages of the invention can be found in the dependent claims, in the drawings, and in the pertinent description of the figures with reference to the drawings.

It is understood that the features described above and those to be described in what follows can be used not only in the particular cited combination; but also in other combinations or independently without departing from the scope of the present invention.

Preferred embodiments of the invention are shown in the drawings and are described in more detail in the following description, the same reference numerals referring to components which are the same or functionally the same or similar.

It is shown in schematic diagrams in

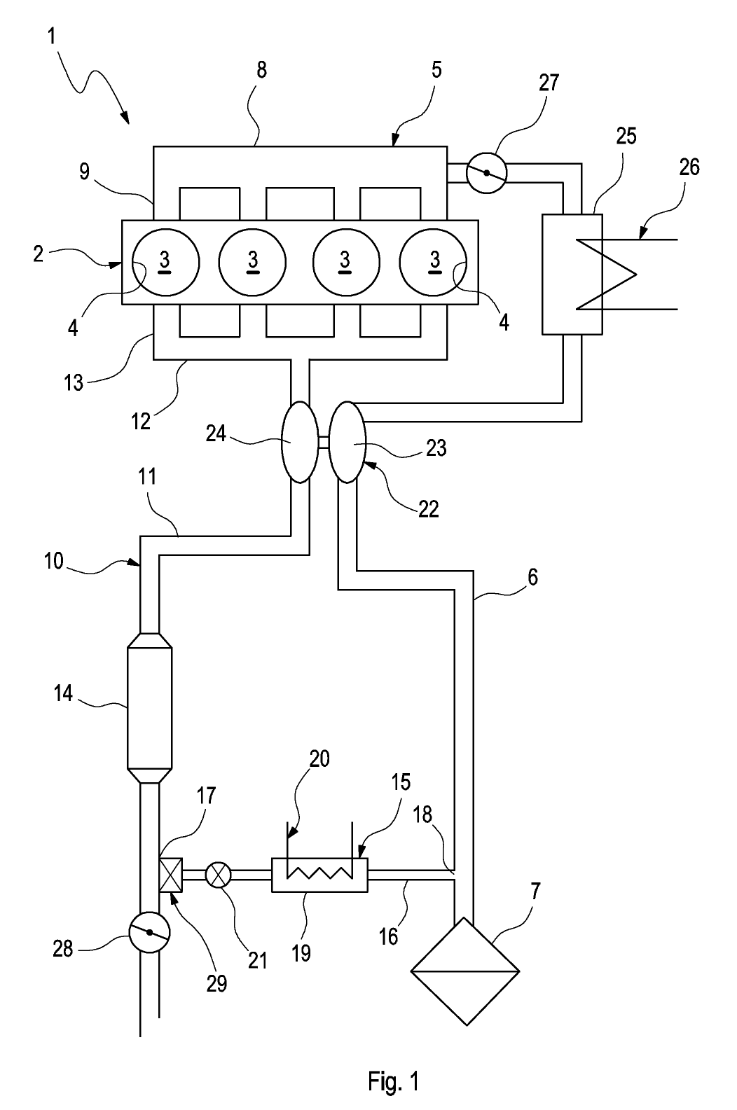

FIG. 1 a greatly simplified circuit-diagram-like schematic representation of an internal combustion engine,

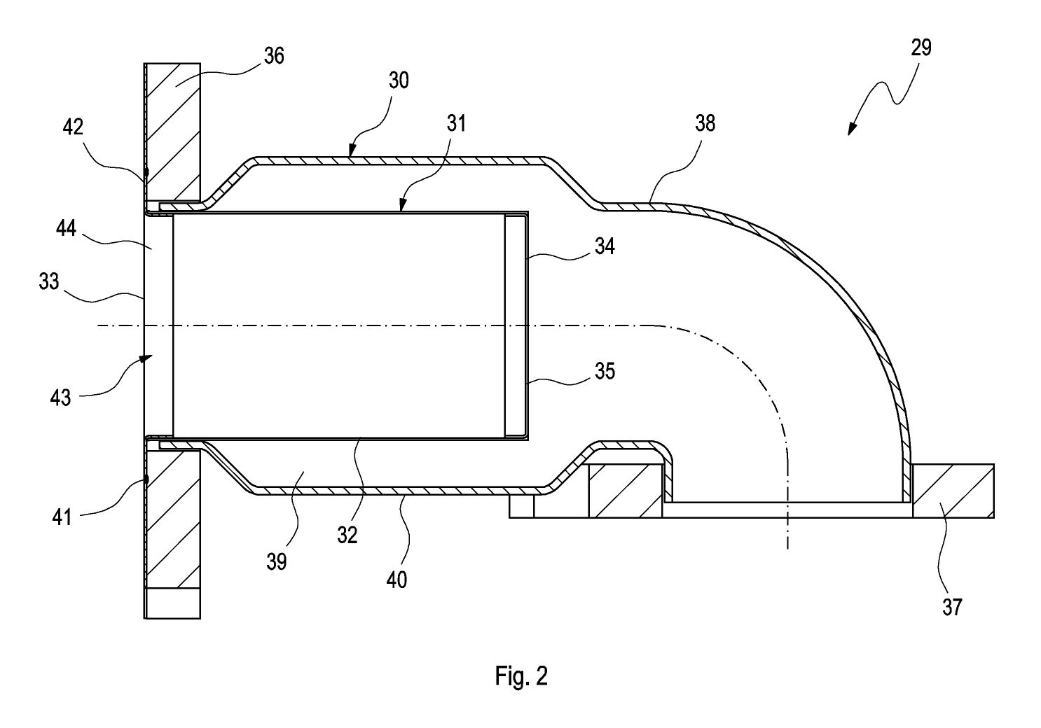

FIG. 2 a simplified longitudinal section through a purification system will configure it as a filter device including an inserted filter body,

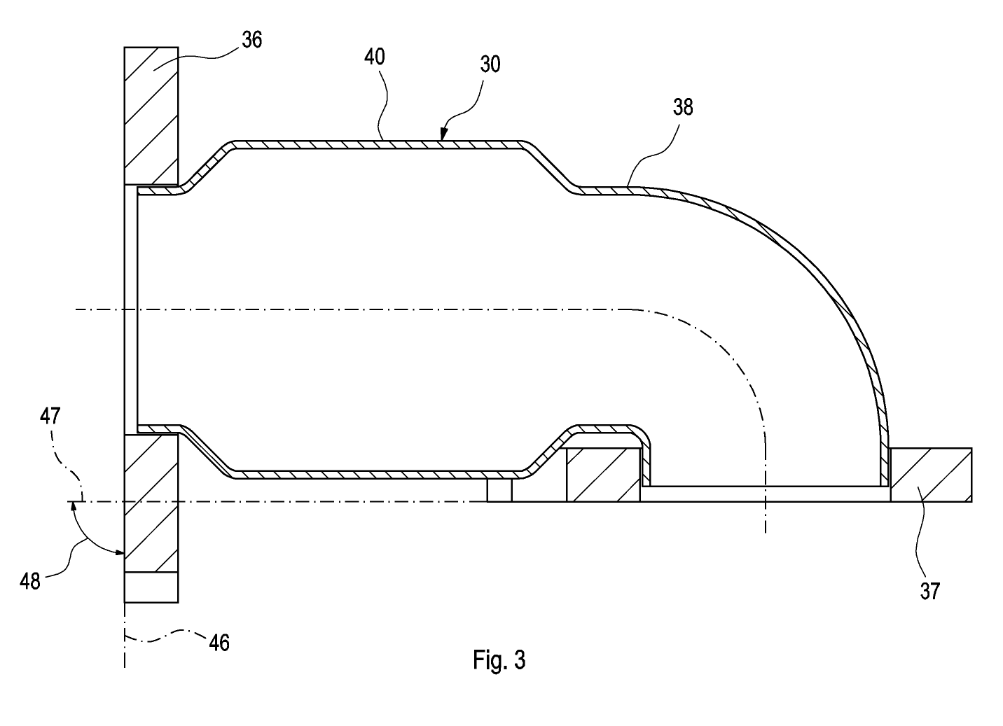

FIG. 3 a sectional view as in FIG. 2, however without the filter body,

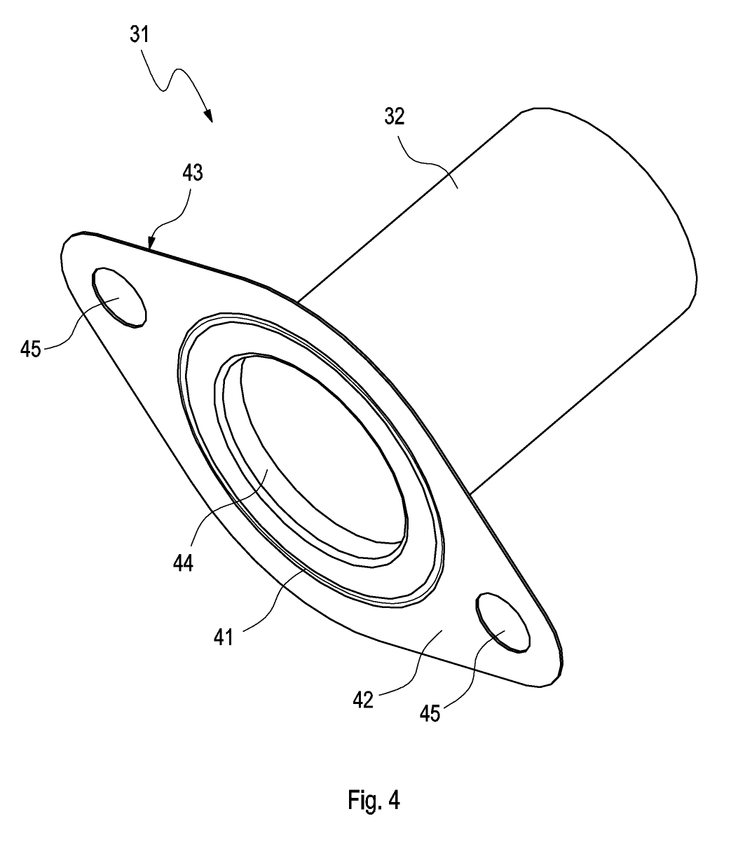

FIG. 4 a perspective view of the filter body,

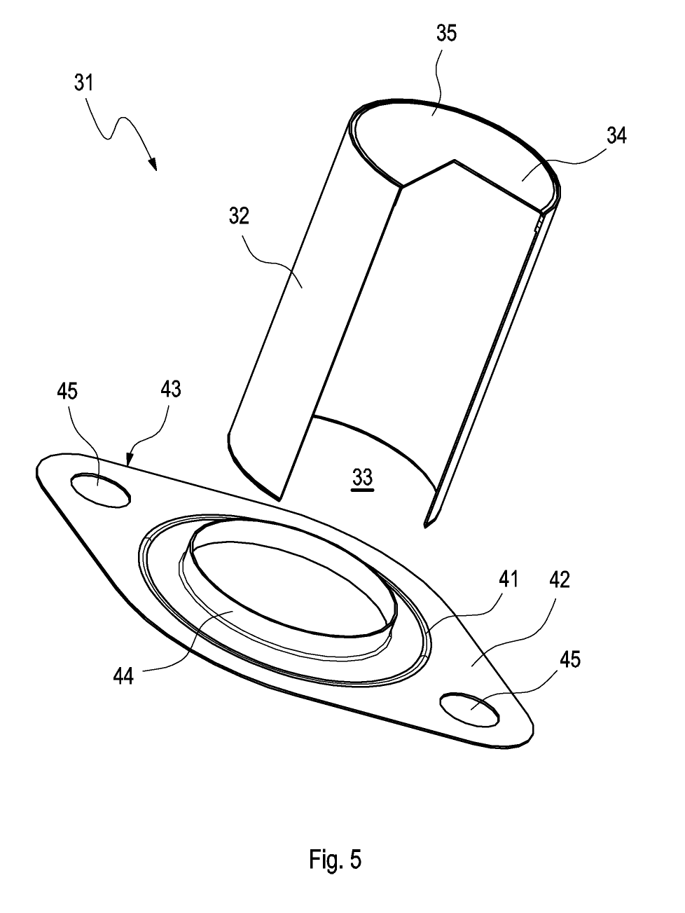

FIG. 5 a perspective representation of the filter body in which said filter body is taken apart and is represented in a partially sectional manner,

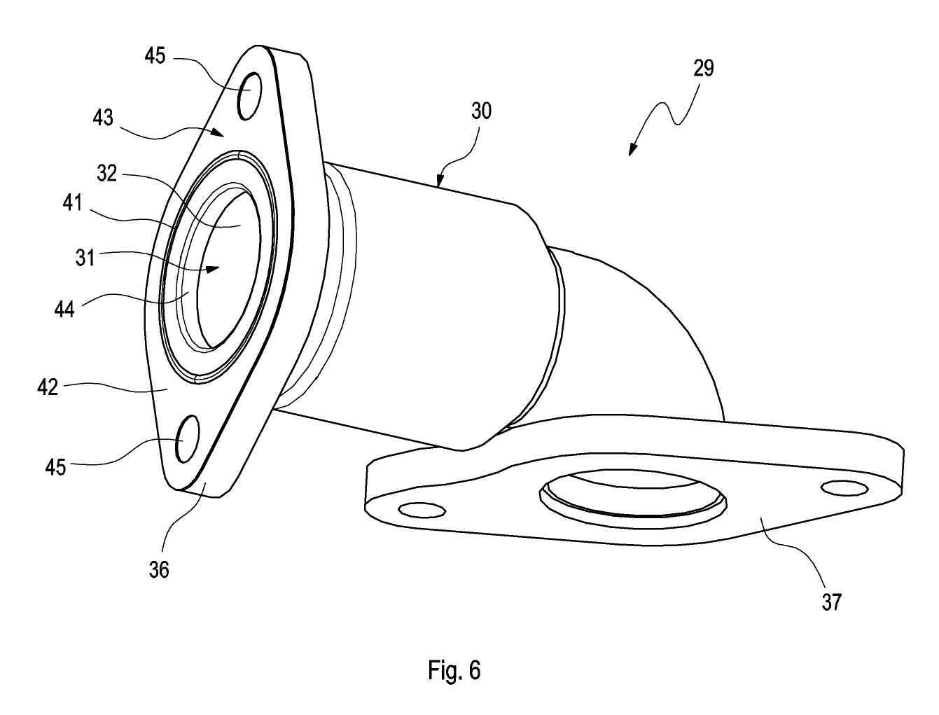

FIG. 6 a perspective view of the purification system configured as the filter device.

Corresponding to FIG. 1, an internal combustion engine 1, which can be arranged in a motor vehicle, comprises an engine block 2 that contains a plurality of combustion chambers 3. In the example, for combustion chambers are shown without limiting generality. The combustion chambers 3 are each located in a cylinder 4 in which a piston, which is not shown, is arranged in a stroke-adjustable manner. To this extent, the internal combustion engine 1 is a piston engine that can be configured as a diesel engine or as a petrol engine. An in-line engine is shown. A V-engine or a horizontally opposed engine is likewise conceivable. The internal combustion engine 1 furthermore has a fresh-air apparatus 5 by means of which fresh air reaches the combustion chambers 3. In the example, the fresh-air apparatus 5 has a fresh-air line 6, in which air line an air filter 7 is arranged, and said air line furthermore leads to a fresh-air distributor 8 that supplies the fresh air to the individual combustion chambers 3 by means of individual pipes 9. Furthermore, the internal combustion engine 1 comprises an exhaust-emission system 10 by means of which the exhaust gas is directed away from the combustion chambers 3. The exhaust-emission system 10 has, for example, an exhaust-gas line 11 that begins at an exhaust-gas collector 12 that itself is connected to the combustion chambers 3 by means of an individual pipes 13. The exhaust-emission system 10 can contain a particle filter 14 that is arranged in the exhaust-gas line 11. Moreover, the exhaust-emission system 4 can furthermore contain additional exhaust-gas purification systems, such as an SCR catalyst, for example, that is conventionally arranged downstream from the particle filter 14, while said exhaust-emission system can furthermore contain an oxidation catalyst that is conventionally arranged upstream from the particle filter 14. The particle filter 14 is advantageously arranged downstream from the turbine 24 in such a manner that the turbine 24 provides as much exhaust-gas enthalpy as possible. Moreover, silencer arrangements may also be present.

The internal combustion engine 1 is furthermore equipped with an exhaust-gas recirculation system 15 that is also characterized in the following as an EGR-system 15. It serves to recirculate exhaust gas from the exhaust-emission system 10 to the fresh-air apparatus 5. The EGR-system 15 has for this purpose an exhaust-gas recirculation line 16 that is also characterized in the following as EGR-line 16. The EGR-line 16 is connected to the exhaust-emission system 10 by means of a removal point 17 or is connected to the exhaust-gas line 11 of said removal point and is furthermore connected to the fresh-air apparatus 5 or to the fresh-air line 6 thereof by means of an introduction point 18. The removal point 17 is positioned downstream from the particle filter 14. The introduction point 18 is positioned downstream from the air filter 7. The EGR-system 15 contains an exhaust-gas recirculation cooler 19 in the EGR-line 16, said exhaust-gas recirculation cooler also being characterized in the following as an EGR-cooler 19. The EGR-cooler 19, for example, be connected to a cooling circuit 20 that itself can be coupled in a heat-transferring manner to a cooling circuit of the internal combustion engine 1 in order to cool the engine block 2 or can form a component thereof. The EGR-system 15 furthermore has an exhaust-gas recirculation valve 21 that can also be characterized as an EGR-valve 21. In the example, the EGR-valve 21 is arranged in the EGR-line 16 upstream from the EGR-cooler 19. Likewise thought home to a range the EGR-valve 21 downstream from the EGR-cooler 19 in the EGR-line 16. The EGR-valve 21 can also be integrated in the EGR-cooler 19 at the entry side or at the exit side.

The internal combustion engine 1 shown here is charged. That means that it has a charge direction 22 by means of which the pressure level in the fresh air, which is supplied to the combustion chambers 3 by means of the fresh-air apparatus 4, can be increased. The mass flux and thus the power density of the internal combustion engine 1 can thereby be increased. In the example shown, the charging device is configured as an exhaust-gas turbocharger 22 that has a compressor 23 that is arranged in the fresh-air apparatus 5 or in the fresh-air line 6 thereof as furthermore has a drive-connecting turbine 24 that is arranged in the exhaust-emission system 10 or in the exhaust-gas line 11 thereof. In the fresh-air apparatus 5 or in the fresh-air line 6 thereof, a charging air cooler 25 can optionally be arranged downstream from the compressor 23. Said charging air cooler is preferably connected to a cooling circuit 26 that itself can be connected in a heat-transferring manner, for example, to the previously-mentioned cooling circuit of the internal combustion engine 1 in order to cool the engine block 2 or alternatively it can form a component thereof. In the example, a throttle valve 27 is moreover shown purely by way of example, said throttle valve being arranged in the fresh-air apparatus 5 for example, in the fresh-air line 6, and namely downstream from the charging air cooler 25 and upstream from the fresh-air distributor 8. Likewise, the valve 27 can be integrated in the fresh-air distributor 8 at the entry side. Moreover, a valve-free configuration of the fresh-air apparatus 5 is in theory conceivable.

The exhaust-emission system 10 optionally has in the example an exhaust-gas throttle 28 that is arranged in the exhaust-gas line 11 downstream from the removal point 17. By means of the exhaust-gas throttle 28, the pressure in the exhaust gas upstream from said exhaust-gas throttle 28 can be increased if needed in order to increase the pressure difference between the removal point 17 and the introduction point 18. This pressure difference drives the recirculated exhaust gas. Depending on the operational state of the internal combustion engine 1, it can be necessary to generate back pressure by means of the exhaust-gas throttle 28 in order to be able to adjust a desired exhaust-gas recirculation rate, or, briefly EGR-rate.

The internal combustion engine 1 is moreover equipped with a purification system 29 by means of which liquid or solid particles can be removed from the recirculated exhaust gas. In the present context, the term “recirculated exhaust gas” is to be understood as exhaust gas that is already located in the exhaust-gas recirculation system 15, that is to say that it is no longer in the exhaust-emission system 10. As soon as the exhaust gas exists from the exhaust-line 11 by means of the removal point 17, it is considered recirculated exhaust gas. It can, however, already be present in the fresh-air apparatus 5 in the form of a mixture composed of fresh air and recirculated exhaust gas. The purification system 29 is, in the example shown, arranged in the EGR-system 15, and namely in the EGR-line 16 thereof. Furthermore, the purification system 29 in the example in FIG. 1 is arranged directly at the removal point 17, that is to say at the input side of the EGR-line 16. In the example, the purification system 29 is positioned in the EGR-line 16 upstream from the EGR-cooler 19 as well as upstream from the EGR valve 21.

The purification system 29 can alternatively also be arranged in the fresh-air apparatus 5 or in the fresh-air line 6 thereof, and namely upstream from the compressor 23 and downstream from the introduction point 18. Owing to the arrangement of the purification system 29 in the fresh-air apparatus 5, condensation droplets can also, for example, be removed from the air stream that is formed by a mixture of fresh air and recirculated exhaust gas. Such condensation droplets can accumulate in the fresh-air apparatus 5 and likewise represent a potential for damage to, for example, the compressor 23.

In a different embodiment, in can alternatively be provided that the purification system 29 is exposed to the entire exhaust-gas stream, that is to say it is configured to remove liquid or solid particles from the exhaust gas. To this end, the purification system 29 is integrated in the exhaust-gas line 11 downstream from the particle filter 14 and upstream from the removal point 17. In this manner, it is likewise achieved that no particles reach the compressor 23, for example by way of the recirculation of the exhaust gas.

The purification system 29 is, in particular, configured in such a manner that the desired purification effectiveness, in particular on a large scale, is not as favourable as the purification effectiveness of the particle filter 14. It is thereby achieved that the purification system 29 has a comparably lower flow resistance. At the same time, allowance must be made for the instance in which the purification system 29 is not intended to take on the task of the particle filter 14, but rather to remove particles from the exhaust gas that detach from the filter material of the particle filter 14 during operation.

In theory, the purification system 29 can be configured in any manner whatsoever. However, preferred or those in embodiments in which an effective exhaust-gas purification can be realised with the smallest amount of pressure loss possible. Therefore, and embodiment is preferred in which he purification system 29 is configured as a filter device that is likewise referred to with reference numeral 29 in the following. A preferred embodiment of such a filter device 29 is explained in greater detail in the following using FIGS. 2 to 6.

Corresponding to FIGS. 2 to 6, such a filter device 29 comprises a filter housing 30 and a filter body 31 arranged therein. The filter body 31 can be flowed through and is here arranged in the filter housing 30 in such a manner that exhaust gas advantageously flows through it. The filter body 31 is configured to be permeable to exhaust gas while those liquid or solid particles that are to be removed from the exhaust gas cannot pass through it. For example, the filter body 31 or its filter material 32 is configured in such a manner that it filters out particles from the exhaust gas when the grain size thereof exceeds a pre-determined maximum value. For example, this maximum value can be selected in such a manner that particles having grain sizes greater than 100 μm or greater than 150 μm or greater than 200 μm or greater than 250 μm or greater than 300 μm are filtered out.

The filter material 32 used for this purpose can, for example, be a mesh, filament or cloth. Ordered structures are preferred, such as a cloth or a mesh, by means of which a desired purification effectiveness with regard to a certain grain size of the particles to be filtered out as well as a flow resistance that is as small as possible can both be realised. Orifice structures such as, for example, a filament are, however, also conceivable in principle. Should the filter device 29 be used upstream from the EGR-cooler 19, it is recommended to configure the filter material as correspondingly resistant to heat. Therefore, it preferably consists of a metallic material. Accordingly, the wires in a wire cloth, knitted wire filaments or knitted wire mesh of the filter material 32 or preferably metal wires. If the filter device 29 is used downstream from the EGR-cooler 19, other material is having less favourable heat resistance can also be used, such as, for example plastics. In particular, other conventional filter material is can also be used such as, for example, felt filters or paper filters.

In the example shown in FIGS. 2 through 6, the filter body 31 or its filter material 32 is configured annularly or hollow cylindrically. Accordingly, the filter material 32 forms a sheath body. Here, the filter body 31 is configured to be open on an axial side 33. In the example shown, the filter body 31 is closed by a floor 35 on the opposite axial side 34. The floor 35 can be configured so as to be impermeable to gas. In that instance, it would not consist of the filter material 32, in particular. It is likewise also possible to produce the floor 35 from the filter material 32 so that exhaust gas can likewise flow through said floor, which can also contribute to increasing the surface area of the filter. The floor 35 can be integrally formed from one piece with the sheath body or, as in the example shown, the attached to the sheath body by means of soldering or welding, for example. In the example shown, the filter body 31 or its filter material 32 are configured to have a pot-like shape. The shape presented here can be comparably easily manufactured. It is, however, understood that in theory, other shapes can also be realised, such as a spherical shape or a conical one.

Corresponding to FIGS. 2, 3, and 6, the housing 30 has at least one housing flange 36. In the example, the housing 30 has two housing flanges 36 and 37. By means of the respective housing flanges 36, 37, the filter housing 30 can be detachable the attached to complementary counter-flanges in the assembled state by means of corresponding screws, for example. Said counter-flanges can, for example be formed on the exhaust-emission system 10 and/or on the exhaust-gas recirculation system 15 and/or on the fresh-air apparatus 5 depending on the installation location of the filter device 29. In the example, the filter housing 30 as a tubular body 38 in which the exhaust gas is conducted. The tubular body 38 can have a broadened cross-section in the region of the filter body 31 that is inserted therein in order to form an annular chamber 39 that coaxial the surrounds said filter body 31. The cross-section expansion of the tubular body 38 that is given reference numeral 40 makes it possible for the filter body 31 to use a cross-section that is as large as possible in order to increase the filter surface available for filtering. The larger the filter surface is, the smaller the current resistance of the filter body 31, while exhibiting the same degree of filtration. In order to further increase the filter surface area available or in order to further reduce the current resistance of the filter body 31, egg is also possible in theory to arrange the filter material 32 in the circumferential direction as wave-shaped or zigzag-shaped or star-shaped. In this manner, the filter surface area that is available can be multiplied with respect to the simple sheath surface.

In the example, both of the housing flanges 36, 37 or manufactured separately with respect to the tubular body 38 and are attached to the tubular body 38 in a suitable manner. In particular, the flanges 36, 37 or welded to the tubular body 38 or are soldered thereto. Likewise, an integral construction manner is also conceivable with which the tubular body 38 is integrally manufactured from one piece with the housing flanges 36, 37 formed thereon.

In the assembled state, a seal can be provided between the flanges that are attached to one another, that is to say between the respective housing flanges 36, 37 and the counter-flange that is complementary thereto and not shown here. Such a seal is given reference numeral 41 in FIGS. 2 and 4 to 6. It is axially effective and is axially tensioned between the flanges that are stayed or screwed together.

Corresponding to FIGS. 2 and 4 to 6, the filter body 31 can have a flange section 42 in a preferred embodiment. This flange section 42 can be integrally formed on the filter body 31. A multi-part construction is likewise conceivable. In the example shown, the flange section 42 is configured on a flange body 43 that is separately manufactured from the filter material 32. The flange body 43 has, for example, an axially-protruding, annularly circumferential collar 44 on which the filter body 31, that is to say the filter material 32 or the cylinder body formed therewith, is axially attached. The collar 44 can likewise be attached to the cylinder body or to the filter material 32. In the region of this collar 44, the flange body 43 and the filter material 32 can be attached to one another in a suitable manner. For example, they can be attached by means of soldering or welding, in particular by point welding.

In the shown, preferred example, the flange section 42 or the flange body 43 had a shaped contour that it is complementary to the associated housing flange 36. In this manner, the flange section 42 can be easily integrated into the flange connection of the respective housing flange 36 and of the counter-flange connected thereto. Accordingly, said a flange section 42 is arranged in the assembled state between the flanges that are attached to one another. In the example, the flange section 42 is thus arranged between the housing flange 36 and the associated counter-flange and is axially tensioned therebetween. In this manner, the filter body 31, which is in the filter housing 30, connected to the flange section 42 can be positioned in a pre-determined manner and relatively fixed to said filter housing.

In the particularly advantageous embodiment shown here, is the previously-mentioned seal 41 integrated in the flange section 42. The seal 41 can, for example, be formed by an annularly circumferential bead or protrusion that protrudes on one side of the flange section 42.

Depending on the installation site of the filter device 29, the flange section 42 or the flange body 43 is manufactured from a metal or, alternatively, out of plastic. Correspondingly, this also applies to the seal 41. For example, the flange body 43 can be manufactured from a sheet metal moulded part that can be manufactured integrally with the annular collar 44 and the seal 41 as well as with openings 45 from one single piece of sheet metal. The openings 45 serve to guide screws with which the housing flange 36 is screwed together with the associated counter-flange.

Corresponding to FIG. 3, both of the flanges 36, 37 are respectively positioned in a flange plane 46, 47. In the example shown, both of the flange planes 46, 47 extend inclined toward one another. In particular, both of the flange planes 46, 47 can be perpendicular to one another, that is to say include an angle 48 of 90° between one another.

1-17. (canceled)

18. An internal combustion engine, in particular in a motor vehicle, comprising
an engine block that contains a plurality of combustion chambers,
a fresh-air apparatus for supplying fresh air to the combustion chambers,
an exhaust-emission system for removing the exhaust gas from the combustion chambers,
an exhaust-gas recirculation system for recirculating exhaust gas from the exhaust-emission system to the fresh-air apparatus,
a purification system for removing liquid or solid particles from the recirculating exhaust gas.

19. The internal combustion engine as specified in claim 18, wherein the purification system is arranged in the exhaust-gas recirculation system or in the fresh-air apparatus down stream from an introduction point at which the exhaust-gas recirculation system is connected to the fresh-air apparatus.

20. The internal combustion engine as specified in claim 18, wherein the exhaust-gas recirculation system in a charged internal combustion engine is configured as a low-pressure exhaust-gas recirculation system.

21. The internal combustion engine as specified in claim 18, wherein the purification system is arranged upstream from a charging device arranged in the fresh-air apparatus, and/or

22. The internal combustion engine as specified in claim 18, wherein the purification system is arranged upstream from and exhaust-gas recirculation cooler arranged in the exhaust-gas recirculation system.

23. The internal combustion engine as specified in claim 18, wherein the purification system is arranged upstream from and exhaust-gas recirculation valve arranged in the exhaust-gas recirculation system.

24. The internal combustion engine as specified in claim 18, wherein the purification system is configured as a filter device that has a filter body through which exhaust gas can pass but which is impermeable to the particles to be removed.

25. The internal combustion engine as specified in claim 24, wherein the filter body has as a filter material a mesh or a wire mesh or a filament or wire filaments or a cloth or a wire cloth, wherein the filter material consists in particular of a metallic substance.

26. The internal combustion engine as specified in claim 24, wherein the filter body has a filter material that is designed and/or arranged annularly and/or hollow cylindrically and/or in a pot-shaped manner and/or spherically.

27. The internal combustion engine as specified in claim 24, wherein the filter body is configured to be axially open on at least one axial side.

28. The internal combustion engine as specified in claim 24, wherein the filter device has a filter housing in which the filter body is inserted.

29. The internal combustion engine as specified in claim 28, wherein the filter housing forms an annular chamber coaxially surrounding the filter body.

30. The internal combustion engine as specified in claim 28, wherein the filter housing has at least one housing flange that, in the installed state, is detachable the attached to a complementary counter-flange of the exhaust-emission system and/or of the exhaust-gas recirculation system and/or of the fresh-air apparatus in order to exchange the filter body.

31. The internal combustion engine as specified in claim 30, wherein a seal is provided that is arranged between the flanges that are attached to one another in the assembled state.

32. The internal combustion engine as specified in claim 26, wherein the filter body has a flange section that is arranged between the flanges that are attached to one another for the purposes of positioning and/or fixing the filter body in the filter housing in the assembled state.

33. The internal combustion engine as specified in claim 31, wherein the seal is configured integrally on a flange section of the filter body.

34. The internal combustion engine as specified in claim 28, wherein the filter housing is manufactured from one piece or a tubular body and has one or two housing flanges attached thereto.

35. The internal combustion engine as specified in claim 28, wherein the filter housing has two housing flanges with which the filter housing in the assembled state is detachably connected to complementary counter-flanges of the of the exhaust-emission system and/or of the exhaust-gas recirculation system and/or of the fresh-air apparatus.

36. The internal combustion engine as specified in claim 35, wherein both of the housing flanges each respectively lies in a flange plane, which are inclined toward one another, in particular around approximately 90°.

37. The internal combustion engine as specified in claim 18, wherein the purification system is arranged in the exhaust-emission system downstream from a particle filter for removing liquid or solid particles from the exhaust gas.

38. A filter body for an internal combustion engine as specified claim in 18.
